(19) United States
(12) Patent Application Publication
(10) Pub. No.: US 2005/0268802 A1
(43) Pub. Date: Dec. 8, 2005

(54) Printer for cutting patterns in paper

(76) Inventors: Charles Evans, Corvallis, OR (US); James R. Emmert, Corvallis, OR (US); Michael A. Rencher, Corvallis, OR (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/859,698

(22) Filed: Jun. 2, 2004

(51) Int. Cl. B41F 13/56

(52) U.S. Cl. 101/226

(57) ABSTRACT

A printer that is capable of automatically cutting precise and repeatable patterns into paper. A printer according to the present teachings includes a cutting tool for cutting a pattern into a paper, a paper feeder that moves the paper through the printer to provide a vertical component of the pattern, and a carriage that moves the cutting tool across the paper to provide a horizontal component of the pattern.

### BACKGROUND

It may be desirable under a variety of circumstances to cut a pattern into a paper. For example, it may be desirable to cut a border pattern into the edges of a printed document or to cut individual sheets of paper into a variety of desired shapes.

Prior methods for cutting a pattern into a paper may employ a pattern cutting tool. For example, a pattern cutting tool may include a template that defines a pattern to be cut into a paper and a cutting blade that enables a user to manually cut the paper along the template pattern. A user may manually place the template on the paper, cut the pattern along the template with the cutting blade, then place the template in a position to continue the pattern and then continue cutting the pattern.

Unfortunately, a method that employs a cutting tool may create inaccuracies in a pattern if the user does not accurately place the cutting tool. In addition, the repeated repositioning of a cutting tool by a user may greatly increase the time spent on cutting the pattern into the paper. Moreover, a method that employs a cutting tool may be labor intensive and may increase the time and cost associated with cutting patterns into large numbers of papers.

### SUMMARY OF THE INVENTION

A printer is disclosed that is capable of automatically cutting precise and repeatable patterns into paper. A printer according to the present teachings includes a cutting tool for cutting a pattern into a paper, a paper feeder that moves the paper through the printer to provide a vertical component of the pattern, and a carriage that moves the cutting tool across the paper to provide a horizontal component of the pattern.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows a printer that is capable of cutting a pattern into a paper according to the present teachings;

FIG. 2 shows an example of a pattern to be cut into an edge of a paper;

FIG. 3 is a side view of one embodiment of a printer according to the present teachings that shows additional detail of a paper feeder and a cutting tool;

FIG. 4 is a side view of another embodiment of a printer according to the present teachings that includes an additional set of rollers;

FIG. 5 illustrates one embodiment of a cutting controller;

FIG. 6 shows a printer according to the present teachings connected to a computer system via a communication path.

### DETAILED DESCRIPTION

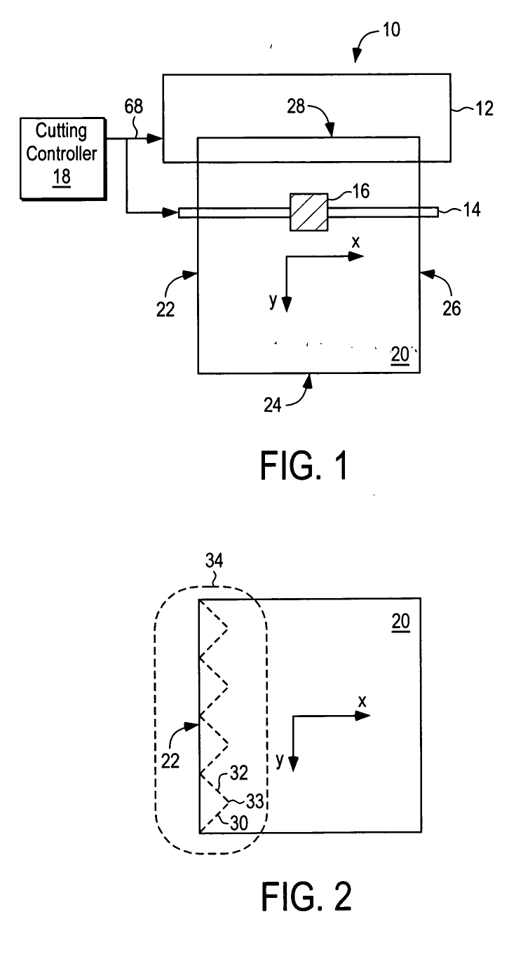

FIG. 1 shows a printer 10 that is capable of cutting a pattern into a paper 20 according to the present teachings. The printer 10 includes a paper feeder 12 and a carriage 14 having a cutting tool 16. The printer 10 also includes a cutting controller 18 that generates a set of control signals 68 that control the movements of the paper feeder 12 and the cutting tool 16. In one embodiment, the cutting controller 18 is capable of cutting border shapes, patterns, etc., in any one or more of a set of edges 22-28 of the paper 20.

The cutting controller 18 moves the carriage 14 and its cutting tool 16 in a horizontal direction with respect to the paper 20 along an x axis. The cutting tool 16 may be moved along the carriage 14 in both the positive x and the negative x directions under control of the cutting controller 18.

The cutting controller 18 uses the paper feeder 12 to move the paper 20 in a vertical direction along a y axis. In one embodiment, the paper feeder 12 is capable of moving the paper 20 in both the positive y and the negative y directions under control of the cutting controller 18.

The cutting controller 18 actuates the paper feeder 12 and the carriage 14 to cut a pattern the paper 20 using the cutting tool 16. The movement of the carriage 14 along the x axis provides a horizontal component of a pattern cut into the paper 20 while the movement of the paper 20 along the y axis provides a vertical component of the pattern cut into the paper 20.

The paper feeder 12 may be the same paper feeder that is used for positioning the paper 20 with respect to a printing mechanism (not shown) in the printer 10. The paper feeder 12 may be embodied as any type of paper feed mechanism, e.g. motor driven rollers, etc. to move the paper 20 in the positive and negative y directions.

In some embodiments, the carriage 14 is the same mechanism that acts as a carriage for a print head (not shown) of the printer 10. In other embodiments, the carriage 14 is a separate mechanism provided for moving the cutting tool 16. The carriage 14 may be embodied as any type of carriage mechanism, e.g. motor and belt drive, etc. to move the cutting tool 16 in the positive and negative x directions.

FIG. 2 shows an example of a pattern 34 to be cut into the edge 22 of the paper 20. The pattern 34 is a zigzag pattern that includes a series of reversing 45 degree angled-edges, e.g. an edge 30 and an edge 32, with respect to the x and y axes. The pattern 34 is provided as an example of shaping the borders of the paper 20 for purposes of illustration. The printer 10 according to the present techniques may cut any pattern into the paper 20.

The cutting controller 18 cuts the edge 30 of the pattern 34 by moving the paper 20 in the positive y direction while moving the cutting tool 16 in the positive x direction at substantially the same rate of movement. At a point 33 in the pattern 34, the cutting controller 18 reverses the direction of movement of the cutting tool 16 to cut the edge 32. The cutting controller 18 cuts the edge 32 by moving the paper 20 in the positive y direction while moving the cutting tool 16 in the negative x direction at substantially the same rate of movement.

The cutting controller 18 may control the angles of the edges 30-32 by controlling the relative speed at which the paper 20 is moved in the y direction and the cutting tool 16 is moved in the x direction.

In one embodiment, the cutting tool 16 includes a rotating blade and the cutting controller 18 turns the rotating blade to align it with the motion of a cut. For example, the cutting controller 18 aligns a cutting edge of the rotating blade at a 45 degree angle having a positive x component and a negative y component while cutting the edge 30 and then aligns the rotating blade at a 45 degree angle having a negative x component and a negative y component while cutting the edge 32.

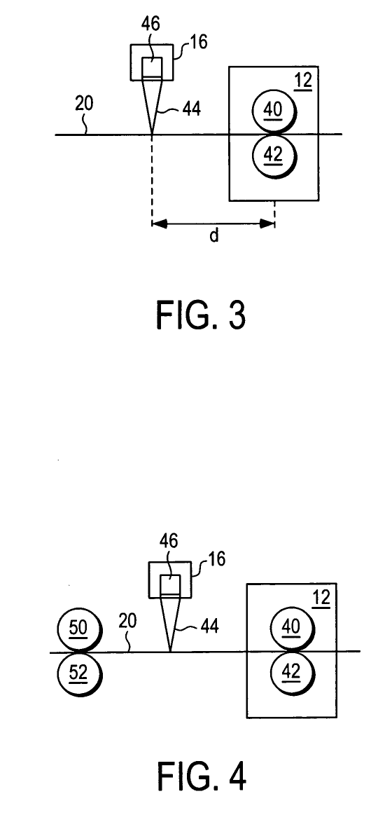

FIG. 3 is a side view of one embodiment of the printer 10 that shows additional detail of the paper feeder 12 and the cutting tool 16.

The paper feeder 12 includes a set of rollers 40-42 that are capable of moving the paper 20 in the y direction in response to the control signals 68 from the cutting controller 18. The cutting controller 18 controls the rate of movement of the paper 20 by controlling the angular speed of a motor (now shown) that drives the rollers 40-42. The cutting controller 18 controls the direction of movement of the paper 20 by controlling the direction of rotation of the motor that drives the rollers 40-42.

The cutting tool 16 includes an actuator 46 that rotates a cutting blade 44 in response to the control signals 68 from the cutting controller 18. The actuator 46 rotates the cutting blade 44 through an angle that is parallel to the x-y plane of the paper 20. In the embodiment shown, it is preferable that a distance d between the cutting blade 44 and the rollers 40-42 be minimized in order to prevent crumpling of the paper 20 as it contacts the cutting blade 44 when dull.

FIG. 4 is a side view of another embodiment of the printer 10 that includes an additional set of rollers 50-52. The rollers 50-52 provide a mechanism for maintaining tension in the paper 20 to prevent crumpling of the paper 20 that might otherwise occur when the paper 20 contacts the cutting blade 44, e.g. when the cutting blade 44 is dull. The rollers 50-52 may be driven by a motor, e.g. the motor that drives the rollers 40-42 or a separate motor, under control of the cutting controller 18.

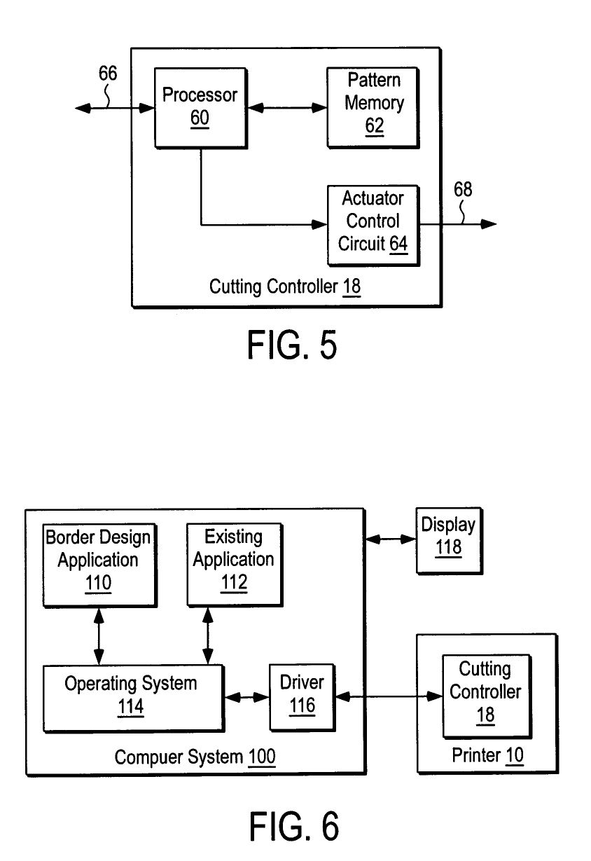

FIG. 5 illustrates one embodiment of the cutting controller 18. The cutting controller 18 includes a processor 60, a pattern memory 62, and an actuator control circuit 64.

The pattern memory 62 stores one or more patterns that may be cut into the paper 20. A pattern may be defined in any manner, e.g. a bit map, vectors, a series of vertices and edges, etc.

The processor 60 obtains data that defines a pattern to be cut into the paper 20 from the pattern memory 62 and in response issue commands to the actuator control circuit 64. The actuator control circuit 64 generates the control signals 68 that control the movements of the paper 20 and the carriage 14 and the cutting blade 44 in response to the commands from the processor 60. For example, the control signals 68 include control signals that control the motor that drives the rollers 40-42, control signals that control the motor for the carriage 14, and control signals for the actuator 46 in the cutting tool 16.

The processor 60 includes mechanisms, e.g. hardware and code, for performing communication via a communication path 66. The processor 60 receives commands and/or data via the communication path 66 that specify a pattern to be cut in the paper 20. A command received via the communication path 66 may specify a pattern that is stored in the pattern memory 62 and that is to be cut into the paper 20. A command received via the communication path 66 may include data that defines a pattern to be cut into the paper 20. The processor 60 may be the same processor that performs printing functions for the printer 10.

FIG. 6 shows the printer 10 connected to a computer system 100 via the communication path 66. The computer system 100 provides a processing platform including an operating system 114 and underlying hardware that enables execution of application programs that may employ the paper cutting functionality of the printer 10. Example application programs that may employ the paper cutting functionality of the printer 10 include a border application 110 and an existing application 112. Examples of the existing application 112 include word processing applications and graphics applications.

The operating system 114 provides mechanisms for installing the printer 10 including a driver 116 that enables the border application 110 and the existing application 112 to access the paper cutting functionality in the printer 10. In one embodiment, the driver 116 is installed on the computer system 100 using the same mechanisms in the operating system 114 for installing printer drivers and the driver 116 is analogous to a printer driver. The border application 110 and the existing application 112 use a print job spooling mechanism of the operating system 114 to send cutting jobs to the printer 10 via the driver 116 and the communication path 66.

The border application 110 enables a user of the computer system 100 to cut patterns into the paper 20. For example, the border application 110 may render an assortment of patterns onto a display 118 along with a user interface that enables a user to select among the individual patterns. In response to user selection of a pattern, the border application 110 calls the driver 116 via the operating system 114 to communicate the selected pattern to the cutting controller 18 as a spooled cutting job. For example, data defining the selected pattern may be transmitted to the cutting controller 18 via the communication path 66 or an identifier for a pattern already stored in the pattern memory 62 may be communicated via the communication path 66 along with a command to cut the pattern.

The border application 110 may enable a user of the computer system 100 to design patterns. For example, the border application 110 may provide drawing tools, e.g. line drawing tools, predefined shapes, etc. that enable a user to create and save patterns. The border application 110 may then transfer a user-created pattern to the cutting controller 18 via the driver 116 and the communication path 66.

The driver 116 may enable a user of the existing application 112 to select from among a set of predefined patterns. For example, a print button in the existing application 112 may cause the driver 116 to display a printer control panel on the display 118. The printer control panel may include a printer properties panel for the cutting functionality of the printer 10. The printer properties panel may include a user selectable list of available predefined patterns that may be cut using the printer 10. The predefined patterns may be stored in the pattern memory 62 or may be transferred to the cutting controller 18 via the communication path 66.

The communication path 66 may be any type of communication path suitable for communication between a computer system and a peripheral device. Examples for the communication path 66 include USB, serial, and parallel ports of the computer system 100, wireless links to the computer system 100, e.g. infrared, radio frequency, as well as wire-based and wireless network links.

The foregoing detailed description of the present invention is provided for the purposes of illustration and is not intended to be exhaustive or to limit the invention to the precise embodiment disclosed. Accordingly, the scope of the present invention is defined by the appended claims.

1. A printer, comprising:
cutting tool for cutting a pattern in a paper such that the pattern includes a vertical component and a horizontal component;
paper feeder that moves the paper to provide the vertical component of the pattern;
carriage that moves the cutting tool across the paper to provide the horizontal component of the pattern.

2. The printer of claim 1, wherein the cutting tool includes a rotating blade that rotates around an axis that is perpendicular to the paper.

3. The printer of claim 1, further comprising a mechanism for providing tension in the paper as the paper contacts the cutting tool.

4. The printer of claim 1, further comprising a memory for storing the pattern.

5. The printer of claim 1, further comprising a mechanism for obtaining the pattern from a computer system.

6. The printer of claim 1, wherein the pattern is a border pattern around a set of edges of the paper.

7. The printer of claim 1, wherein the pattern is a predefined pattern selected by a user.

8. The printer of claim 1, wherein the pattern is a pattern created by a user.

9. A method for cutting a pattern into a paper using a printer wherein the pattern includes a horizontal and a vertical component, comprising:
feeding the paper through the printer to provide a the vertical component of the pattern;
moving a cutting tool across the paper to provide a the horizontal component of the pattern.

10. The method of claim 9, wherein moving a cutting tool comprises moving a carriage in the printer that holds the cutting tool.

11. The method of claim 9, wherein moving a cutting tool includes rotating the cutting tool around an axis that is perpendicular to the paper.

12. The method of claim 9, further comprising providing tension in the paper as the paper contacts the cutting tool.

13. The method of claim 9, further comprising storing the pattern in a memory in the printer.

14. The method of claim 9, further comprising obtaining the pattern from a computer system.

15. The method of claim 9, further comprising obtaining the pattern from a user.

16. A computer system, comprising:
program that enables a user to select a pattern to be cut into a paper such that the pattern includes a vertical component and a horizontal component;
printer having a cutting tool and a paper feeder that moves the paper to cut the vertical component of the pattern into the paper and having a carriage that moves the cutting tool across the paper to cut the horizontal component of the pattern.

17. The computer system of claim 16, wherein the program comprises a driver program that enables the user to select from a set of predefined patterns.

18. The computer system of claim 16, wherein the program comprises a program that enables the user to design the patterns.

19. The computer system of claim 16, wherein the printer includes a memory for storing the pattern.

20. The computer system of claim 16, wherein the printer cuts the pattern into the paper in response to a command from the program.
